(19) United States
(12) Patent Application Publication
(10) Pub. No.: US 2003/0071116 A1
(43) Pub. Date: Apr. 17, 2003

(54) Electronic information transaction system

(76) Inventor: Anil I. Valbh, Orlando, FL (US)

Correspondence Address: Michael I. Kroll, 171 Stillwell Lane, Syosset, NY, 11791, US

(21) Appl. No.: 09/977,759

(22) Filed: Oct. 15, 2001

(51) Int. Cl. G06K 5/00

(52) U.S. Cl. 235/380

(57) ABSTRACT

A system for transferring information electronically. The system includes a scanner for scanning data stored on a magnetic strip of an identification card; a processor for analyzing the scanned data; and a printing device. The printing device prints relevant portions of the scanned data on a medium under control of the processor. The medium is preferably a check presented by a customer to pay for an item. The scanned data includes information concerning the customer such as at least one of an address of the customer, a driver's license of the customer, a social security number of the customer, an address of the customer and a telephone number for the customer. The printing device is also able to print a check for a customer to provide to pay for an item based upon said scanned data analyzed by the processor. The scanning device includes a keypad for inputting additional data for analysis by the processor and a display for displaying data input instructions from the processor. The processor may be positioned within the scanner. Alternatively, the scanner may include a data input port for transmitting the scanned data to an externally located processor and a data input port for receiving data from the externally located processor. The identification card is preferably a driver's license and the scanner is able to read a magnetic strip on driver's licenses from all states within the United States. A memory unit may be provided for storing the scanned data.

### BACKGROUND OF THE INVENTION

1. Field of the Invention

The present invention relates generally to information collection systems and, more specifically, to a system for quickly and accurately collecting information by scanning an identification card, the information scanned being stored in a data base and printed on items used for payment of a debt.

2. Description of the Prior Art

Numerous types of information collection systems have been provided in the prior art. For example, FIG. 1 shows a person 10 paying for an item at a store counter 12 using a check 14. When providing the check 14 for payment, a store clerk 16 normally requires some form of identification such as a driver's license 18. In order to process the transaction and protect the store from receiving bad checks, the clerk 16 normally writes information concerning the person 10 obtained from the driver's license 18. This is a generally tedious process which is both time consuming and prone to errors. The clerk 16 must obtain a pen 20 and copy the information from the driver's license 18 to the check 14. The copying of this information may result in numerous errors. These errors may be caused by simply copying incorrect information on the check 18 or by distractions caused by impatient customer's complaints due to the delay caused by waiting for the transaction to be completed. The mistakes made by the clerk 16 will thus allow bad checks to be accepted with no means for finding the person 10 who paid with the check 18. Additional examples of previous systems are found in U.S. patents numbered U.S. Pat. Nos. 3,624,357; 4,048,618; 472,626; 4,587,409; 4,623,965; 4,810,866; 5,053,607 and 5,237,159 all are illustrative of such prior art.

### U.S. Pat. No. 3,624,357

### Inventor: Lyle E. Wright

### Issued: Nov. 30, 1971

Upon verification of ownership of a credit card, the credit card, a calculator keyboard, and multiple printing apparatus, effect the inscription of all necessary sales transaction information on a voucher constituting a blank check thus giving the seller an unsigned negotiable instrument corresponding to the amount of purchase.

### U.S. Pat. No. 4,048,618

### Inventor: Seth T. Hendry

### Issued Sep. 13, 1977

A method of identifying a check signer comprises the application of a fingerprint of a person to an identification card in invisible ink. The same fingerprint of the person is applied to the check in invisible ink in the presence of a person requested to cash the check. The fingerprint of the identification card is scanned to provide a first set of electrical signals. The fingerprint of the check is scanned to provide a second set of electrical signals. The first and second sets of electrical signals are compared. Comparison or non-comparison of the first and second sets of electrical signals is indicated to indicate the authenticity of the signer.

### U.S. Pat. No. 4,068,213

### Inventor: Yasushi Nakamura et al.

### Issued: Jan. 10, 1978

A merchandise checkout system is disclosed including a credit card reader operated by the customer to obtain credit information used in totalizing the merchandise transaction. A data terminal is utilized by the checkout operator to total the amount of the purchased items. Simultaneously with the operation of the data terminal, the customer operates the credit card reader to read a credit card inserted into the card reader by the customer and on which is magnetically encoded the amount of money, i.e. balance of account, available for use by the customer. If the amount available is greater than the total amount of the purchased items, the total amount is subtracted from the available amount with the result displayed and printed on the receipt and journal records of the data terminal as the amount paid. If the available amount is less than the total amount of the purchased items, the amount available is subtracted from such total of purchased items and the difference displayed as the amount due which is to be paid by the customer to complete the transaction.

### U.S. Pat. No. 4,109,238

### Inventor: Robert V. Creekmore

### Issued: Aug. 22, 1978

A check verification system for providing customer-operated verification of checks at point-of-sale locations. The present system enables a customer to verify several possible kinds of checking functions, including verification of payroll or government checks as well as certain types of personal checks for cash, and sets limits on the number of times each checking function will be verified in a period of time. The system utilizes a number of local point-of-use terminals which are operated by the customer, and which communicate with a remotely-located transaction processor including a positive file of customers who are entitled to verify checks with the present system. The positive check verification files do not require the current bank balance of the customer, and the present system is designed to include persons who are merely the payees of checks and have no checking account or other established relationship with any bank. The present check verification system includes an identification card containing a unique number for each customer; a personal customer code, which is not on the card, is also provided for manual entry into the input terminal by the customer. Check verification is given a positive acknowledgment within the input terminal by printing information including a verification number on the back of the specific check being verified. The printed verification number on the customer-supplied check enables such checks to be factored or purchased for the benefit of the merchant who accepts checks verified by the present system.

### U.S. Pat. No. 4,258,252

### Inventor: Luther G. Simjian

### Issued: Mar. 24, 1981

A postage meter is used in conjunction with a check which serves for updating, i.e. increasing the credit register, by a predetermined sum of money. The check is keyed to the particular meter either prior to or after updating the register, and means are provided to invalidate the check after use and to provide the check with data related to the meter.

### U.S. Pat. No. 4,405,856

### Inventor: Paul Poisson

### Issued: Sep. 20, 1983

An apparatus for recording identifying data relating to the use of a credit card, cheque or the like and for dispensing a receipt disclosing at least part of such data; the apparatus comprises a housing in which a camera is mounted for taking, through a one-way mirror, a picture of the user situated in photographic view of the housing. A height scale and other identifying data are displayed on the inner side of the mirror and are non-visible to the user but in photographic view of the camera. Activation of the apparatus is accomplished when the user inserts the credit card, cheque or the like into an appropriate slot provided in the housing and, if required, the indicated amount in a coin slot. A weight scale may also be provided to identify the weight of the user.

### U.S. Pat. No. 4,472,626

### Inventor: Salomon R. Frid

### Issued: Sep. 18, 1984

A verification system for checks and credit cards is operable for accepting a credit card and transaction receipt, or for accepting a check and an identification card, for transmitting data to a remote verification system and for receiving acceptance or rejection instructions for the transactions based on verification of credit funds availability, and for recording symbols on the transaction receipt or the check.

### U.S. Pat. No. 4,587,409

### Inventor: Kosuke Nishimura et al.

### Issued: May 6, 1986

An electronic bookkeeping device is useful in association with use of credit cards for controlling use of various credit cards. The device stores data relative to the extent of use of each card, and assists a user in making the most effective use of a plurality of credit cards.

### U.S. Pat. No. 4,623,965

### Inventor: Donald K. Wing

### Issued: Nov. 18, 1986

A portable, pocket sized check writing apparatus adapted to perform standard check writing functions incorporates a rectangular box-like housing open at one end for receiving a check cartridge. A keyboard is provided on the exterior of the housing for entry of data. A microprocessor is housed within the housing for receiving, storing and retrieving data. The microprocessor is operatively connected to liquid crystal display means for visually displaying data. A print head positionable relative to the face of a check is provided for printing entries on a check which is sequentially ejected from a stack of checks contained in the check cartridge.

### U.S. Pat. No. 4,810,866

### Inventor: Miles Lord, Jr.

### Issued: Mar. 7, 1989

Apparatus for accommodating a purchaser at a vendor's check-out station or the like with the check writer being provided with a communication line for validating and clearing checks, along with a register for determining the transaction total. The apparatus and system of the present invention further permits the purchaser/customer to insert a check blank from a personal checking account into the writer, and means are provided for printing appropriate indicia on the check blank, including date, payee, and amount of the check, and further having an opening for enabling the person to execute the already-imprinted check.

### U.S. Pat. No. 5,053,607

### Inventor: Steven R. Carlson et al.

### Issued: Oct. 1, 1991

A check processing device is particularly adapted for retailer/customer use at the point-of-sale through use of a MICR read head means, printer means and keypad means which feed information into a CPU which communicates, through an existing telecommunication system, with the customer's bank and the retailer's bank in order to transfer funds from the account of the customer to the account of the retailer.

### U.S. Pat. No. 5,237,159

### Inventor: Thomas S. Stephens et al.

### Issued: Aug. 17, 1993

An Electronic Check Presentment System provides a bank with a fully automated capability for participating in the electronic exchange of check data. It allows banks that utilize the system to take MICR data that has been obtained through check capture methods, selectively extract particular check records and place them in the form of electronic cash letters, transfer the electronic cash letters to selected banks, receive electronic cash letters from other banks, reconcile the electronic cash letters against the paper cash letters when they arrive, and input the electronic MICR data into a database responsible for maintaining check records.

While these units may be suitable for the particular purpose to which they address, they would not be as suitable for the purposes of the present invention as heretofore described.

It is thus desirable to provide a system for placing information on an instrument of payment which is accurate and fast. It is further desirable to provide a system for placing information on an instrument of payment which is able to record the information on a recording medium for printing on the instrument directly by a printer. It is yet further desirable to provide a system for placing information on an instrument of payment which obtains the necessary information by simply swiping an identification card such as a driver's license through a card reader. It is still further desirable to provide a system for placing information on an instrument of payment which is able to produce a negotiable instrument such as a check upon entry of the proper information into the system. It is even further desirable to provide a system for placing information on an instrument of payment which increases the chances of tracking a person able to pass a bad check. It is still further desirable to provide a system for placing information on an instrument of payment which is able to read information from driver's licenses produced by all states in the United States.

### SUMMARY OF THE PRESENT INVENTION

The present invention relates generally to information collection systems and, more specifically, to a system for quickly and accurately collecting information by scanning an identification card, the information scanned being stored in a data base and printed on items used for payment of a debt.

A primary object of the present invention is to provide a system for transferring information electronically that will overcome the shortcomings of prior art devices.

Another object of the present invention is to provide a system for transferring information electronically which is accurate and fast.

A further object of the present invention is to provide a system for transferring information electronically which is able to place information on an instrument of payment which is able to record the information on a recording medium for printing on the instrument directly by a printer.

A yet further object of the present invention is to provide a system for transferring information electronically which obtains the necessary information by simply swiping an identification card such as a driver's license through a card reader.

A still further object of the present invention is to provide a system for transferring information electronically which is able to produce a negotiable check upon entry of the proper information into the system.

A further object of the present invention is to provide a system for transferring information electronically which increases the chances of tracking a person able to pass a bad check.

A further object of the present invention is to provide a system for transferring information electronically which is able to read information from driver's licenses produced by all states in the United States.

Another object of the present invention is to provide a system for transferring information electronically that is simple and easy to use.

A still further object of the present invention is to provide a system for transferring information electronically that is economical in cost to manufacture.

Additional objects of the present invention will appear as the description proceeds.

A system for transferring information electronically is disclosed by the present invention. The system includes a scanner for scanning data stored on a magnetic strip of an identification card; a processor for analyzing the scanned data; and a printing device. The printing device prints relevant portions of the scanned data on a medium under control of the processor. The medium is preferably a check presented by a customer to pay for an item. The scanned data includes information concerning the customer such as at least one of an address of the customer, a driver's license of the customer, a social security number of the customer, an address of the customer and a telephone number for the customer. The printing device is also able to print a check for a customer to provide to pay for an item based upon said scanned data analyzed by the processor. The scanning device includes a keypad for inputting additional data for analysis by the processor and a display for displaying data input instructions from the processor. The processor may be positioned within the scanner. Alternatively, the scanner may include a data input port for transmitting the scanned data to an externally located processor and a data input port for receiving data from the externally located processor. The identification card is preferably a driver's license and the scanner is able to read a magnetic strip on driver's licenses from all states within the United States. A memory unit may be provided for storing the scanned data.

To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWING FIGURES

Various other objects, features and attendant advantages of the present invention will become more fully appreciated as the same becomes better understood when considered in conjunction with the accompanying drawings, in which like reference characters designate the same or similar parts throughout the several views.

FIG. 1 is a perspective view of a person paying for an item using a check and the clerk copying information on the check in the conventional manner;

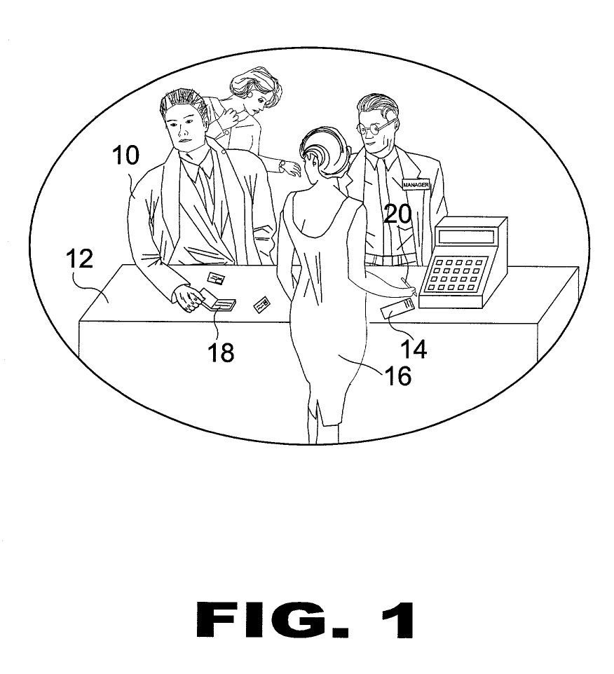

FIG. 2 is a perspective view of a person paying for an item using a check and the clerk copying information on the check according to the system for transferring information electronically of the present invention;

FIG. 3 is a perspective view of the system for transferring information electronically of the present invention;

FIG. 4 is a top side view of a card information reader used in the system for transferring information electronically of the present invention;

FIG. 5 is a side view of the card information reader used in the system for transferring information electronically of the present invention; and

FIG. 6 is an is a block diagram of the card information reader used in the system for transferring information electronically of the present invention.

### DESCRIPTION OF THE REFERENCED NUMERALS

Turning now descriptively to the drawings, in which similar reference characters denote similar elements throughout the several views, the Figures illustrate the system for transferring information electronically of the present invention. With regard to the reference numerals used, the following numbering is used throughout the various drawing figures.

10 person buying an item

12 sales counter

14 check

16 store clerk

18 driver's license

20 pen

30 system for transferring information electronically of the present invention

32 scanning device

34 processing device

36 monitor

38 printer

40 slot in scanning device for passing identification card

42 keypad on scanning device

44 display on scanning device

46 data output line connecting scanning device to processor

48 data input line connecting processor to scanner

50 telephone input line connecting scanner to a telephone network

52 telephone output line connecting processor to telephone system via scanner

54 connection wire connecting printer to processor

56 top side of scanner

58 numerical keypad

60 on hook key

62 enter key

64 print key

66 delete key

68 verify key

70 cancel key

72 back side of scanner

74 power source input port

76 telephone line input port

78 telephone line output port

80 data in port

82 data out port

84 memory unit

86 modem

### DETAILED DESCRIPTION OF THE PREFERRED EMBODIMENT

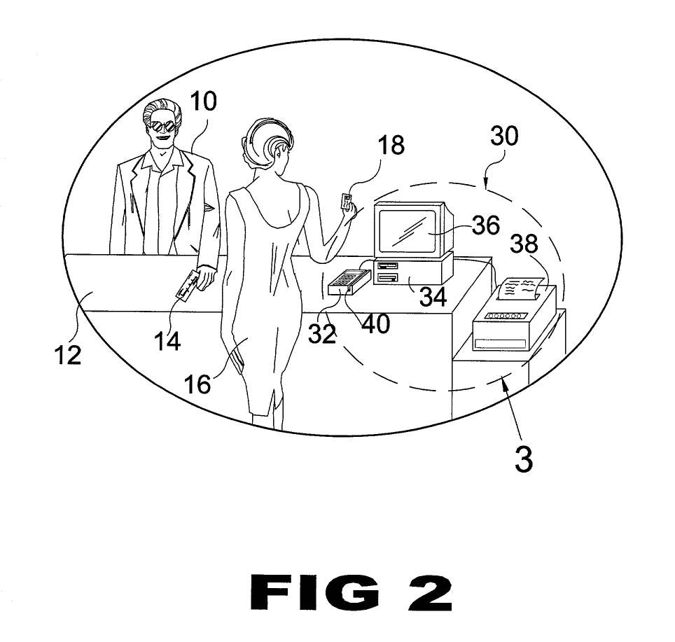

Turning now descriptively to the drawings, in which similar reference characters denote similar elements throughout the several views, FIGS. 2 through 6 illustrate the system for transferring information electronically of the present invention indicated generally by the numeral 30.

The system for transferring information electronically 30 is illustrated in FIG. 2 positioned on the counter 12. The customer 10 is providing the clerk 16 with a check 14. The clerk 16 obtains additional identification 18 from the customer 10 in order to place the identification information on the check 14. The system for transferring information electronically 30 includes a scanning device 32, a processing device 34, a monitor 36 and a printer 38. The scanning device 32 includes a slot 40 through which the identification card 18, i.e. a license, is passed. The scanning device 32 reads the data stored on a magnetic strip on the identification card 18 and provides the data to the processor 34. Any necessary information and instructions are displayed on the monitor 36. The clerk 16 may place the check 14 in the printer 38 and activate the system for transferring information electronically 30 to print the scanned data onto the check 14. As the information is scanned immediately and all data provided on the identification card 18 is read by the scanner 32, the transaction may be completed quickly and with great accuracy.

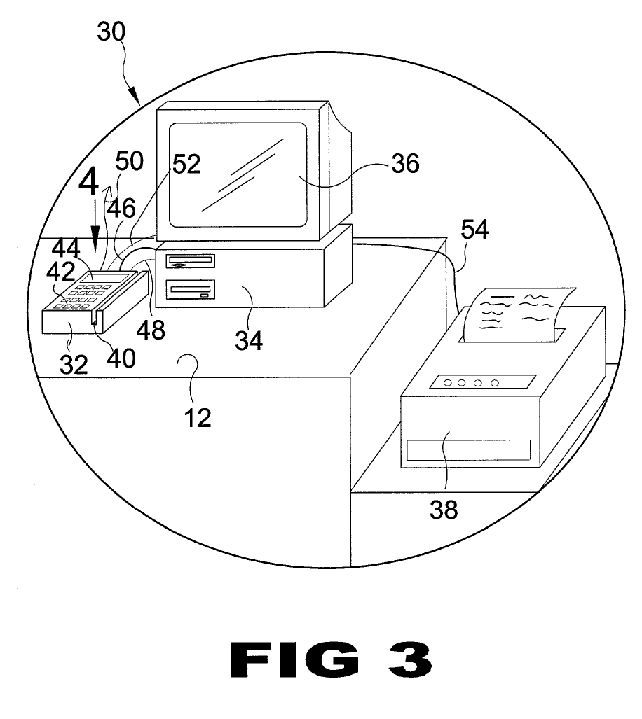

An enlarged view of the system for transferring information electronically 30 is illustrated in FIG. 3. As can be seen from this figure, the system for transferring information electronically 30 includes the scanner 32, processor 34, display 36 and printer 38 connected together. The scanner 32 includes the slot 40 for receiving an identification card to be read. Within the slot 40 is a magnetic strip reader able to read a magnetic strip on the identification card 18. Also provided on the scanner 32 are a keypad 42 and a display 44. The keypad 42 allows the user to input information concerning the customer as well as to provide responses to requests from the processor 34. The display 44 is provided for displaying requests to the user. The scanner 32 is connected to provide data read from the identification card 18 to the processor 34 via a data output line 46. A data input line allows the processor 34 to provide data to the scanner 32. A telephone input line 50 connects the scanner 32 to a telephone network for communicating with other remotely located computers through conventional telephone systems via existing telephone lines. A telephone output line 52 connects the processor 34 to the telephone system via the scanner 32. The printer 38 is connected to the processor 34 via a connection wire 54.

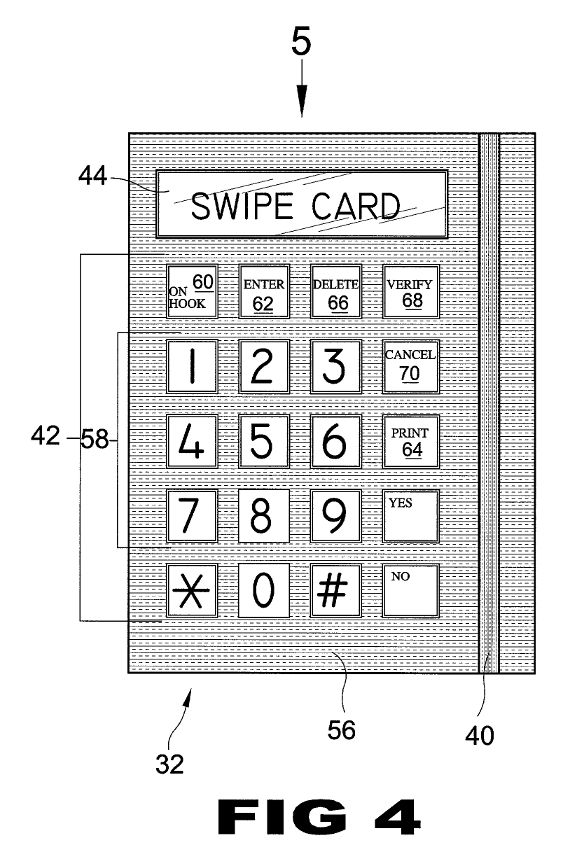

A top side view of the scanner 32 is shown in FIG. 4. This figure shows a top side 56 of the scanner 32 and the components found thereon. The slot 40 is provided to extend along a length of the top side 56. Also positioned on the top side 56 is the keypad 42. The keypad 42 includes a plurality of keys for inputting data. The keys include a numerical keypad 58 for use in dialing a telephone number or inputting numerical information such as an identification number regarding the customer. An on hook key 60 is provided for capturing and releasing a telephone line. An enter key 62 is provided for entering data. A print key 64 is provided for activating the printer 38 to begin printing. Additional keys are also provided such as the delete key 66, verify key 68 and cancel key 70 for performing other miscellaneous functions. The display 44 provides a visual message to the clerk. The visual message guides the clerk through the swiping of the identification card, input of data and printing of information on a check or printing of a check.

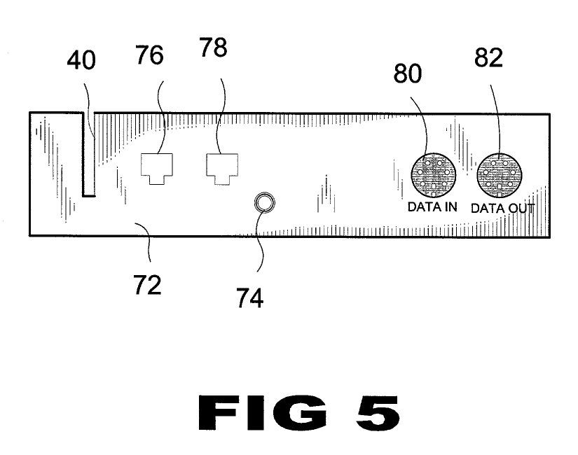

A back side 72 view of the scanner is provided in FIG. 5. This view shows the input and output ports of the scanner 32 used in the system for transferring information electronically 30. The slot 40 is shown extending at least partially into the scanner 32 for receiving an identification card to be scanned. A power supply input port 74 is provided for connection to an external power supply for powering the scanner 32. A telephone line input port 76 is provided for connection of the system for transferring information electronically 30 with a telephone network. A telephone line output port 78 connects the telephone line with the processor 34. A data input port 80 provides a connection for receiving data from the processor 34. A data output port provides a connection for transmitting data to the processor. In an alternate embodiment, the scanner may be directly connected to the printer 38. In this embodiment, the processor will be located within the scanner 32 and perform all the functions associated therewith.

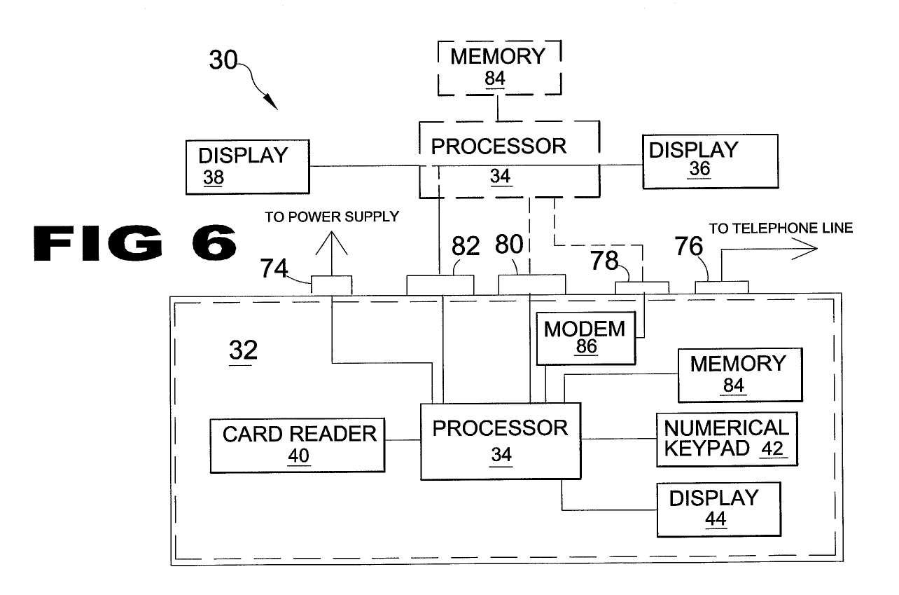

A block diagram of the system for transferring information electronically 30 is illustrated in FIG. 6. As can be seen from this figure, the system for transferring information electronically 30 includes the processor 34. The processor 34 may be a stand alone unit or may be contained within the scanner 32. The processor 34 as a stand alone unit is shown in dashed lines. A memory unit 84 is connected to the processor 34 for storing the programs necessary for operation of the processor 34 and also storing data read by the scanner 32. The memory unit 84 is illustrated in dashed lines when connected to a stand alone processor 34. The power supply port 74 connects an external power supply to the processor 34 for supplying power to the entire system for transferring information electronically 30. The telephone line input and output ports 76 and 78, respectively, as well as the data input and output ports 80 and 82, respectively, are each connected to the processor 34. The telephone line input port 74 is connected tot he processor 34 via a modem 86. When the processor 34 is positioned within the scanner 32, the data output port 82 connects the processor 34 within the scanner 32 directly to the printer 38 and display 36. When the processor 34 is a stand alone unit, the scanner 32 is connected to receive data from the processor 34 via the data input port 80 as shown by the dashed connection line. The telephone output port 78 and data output port 82 are also connected to the processor 34 as shown by the dashed connecting lines. The card reader 40 is connected to the processor 34 for providing data read thereby for analysis. The keyboard 42 is connected to input user entered data to the processor 34 and the scanner display 44 is connected to receive data from the processor 34.

The operation of the system for transferring information electronically 30 will now be described with reference to the figures. In operation, the system for transferring information electronically 30 is generally positioned on a counter 12 within a store. The system for transferring information electronically 30 is used to collect information from a customer in a quick and accurate manner when the customer wishes to purchase goods using a check or other negotiable instrument for which identification may be desired. In use, the clerk accepts a check from the customer as well as some form of identification. The identification is preferably a driver's license and the system for transferring information electronically 30 is preferably able to read a magnetic strip on the license for licenses from all states of the United States. The identification card 18 is inserted into the slot 40 and swiped therethrough. As the identification card 18 is swiped through the slot 40, the scanner 32 reads the magnetic strip and provides the read data to the processor 34. The processor analyzes this data and provides the clerk with instructions regarding any additional information required or on how to proceed via a visual message displayed on the display screen 36 or 44. The clerk 16 is able to input any additional data or respond to any questions by activating the appropriate keys on the keypad 42. The data is input by pressing the numerical keypad 58, enter key 62, delete key 64, verify key 66 and cancel key 68. When it is desired to obtain information from an outside source through the telephone line connection Once all the required data is input via the scanner and keypad, the clerk is instructed to place the check in the printer 38. After the check is placed in the printer 38, the clerk presses the print button 64 in order to print the information on the check. The printer prints the information on the check and the processor 34 stores the information in the memory unit 84 for future reference. The clerk is also able to print a check from the data obtained from the customer. The check to be printed may also include in printed form the amount due from the user. In this manner, the processor works in conjunction with a cash register to determine the amounts due. The customer then signs the check and provides the signed check with the relevant information to the clerk for payment.

From the above description it can be seen that the system for transferring information electronically of the present invention is able to overcome the shortcomings of prior art devices by providing a system for transferring information electronically which is is able to place information on an instrument of payment which is able to record the information on a recording medium for printing on the instrument directly by a printer in an accurate and fast operation. The system for transferring information electronically obtains the necessary information by simply swiping an identification card such as a driver's license through a card reader. The system for transferring information electronically is able to produce a negotiable check upon entry of the proper information into the system thereby increasing the chances of tracking a person able to pass a bad check. The system for transferring information electronically is also able to read information from driver's licenses produced by all states in the United States. Furthermore, the system for transferring information electronically of the present invention is simple and easy to use and economical in cost to manufacture.

It will be understood that each of the elements described above, or two or more together may also find a useful application in other types of methods differing from the type described above.

While certain novel features of this invention have been shown and described and are pointed out in the annexed claims, it is not intended to be limited to the details above, since it will be understood that various omissions, modifications, substitutions and changes in the forms and details of the device illustrated and in its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed is new and desired to be protected by Letters Patent is set forth in the appended claims:

1. A system for transferring information electronically, said system comprising:
a) a scanner for scanning data stored on a magnetic strip of an identification card;
b) a processor for analyzing the scanned data; and
c) a printing device, wherein said printing device prints relevant portions of the scanned data on a medium under control of said processor.

2. The system as recited in claim 1, wherein said medium is a check presented by a customer to pay for an item and said scanned data includes information concerning the customer.

3. The system as recited in claim 2, wherein said relevant information includes at least one of an address of the customer, a driver's license of the customer, a social security number of the customer, an address of the customer and a telephone number for the customer.

4. The system as recited in claim 1, wherein said printing device is able to print a check for a customer to provide to pay for an item based upon said scanned data analyzed by said processor.

5. The system as recited in claim 4, wherein said scanning device includes a keypad for inputting additional data for analysis by said processor.

6. The system as recited in claim 1, wherein said processor is positioned within said scanner.

7. The system as recited in claim 1, wherein said scanner includes a data input port for transmitting said scanned data to said processor and a data input port for receiving data from said processor.

8. The system as recited in claim 1, wherein the identification card is a drivers license.

9. The system as recited in claim 8, wherein said scanner is able to read a magnetic strip on driver's licenses from all states within the United States.

10. The system as recited in claim 1, further comprising a memory unit for storing said scanned data.

11. The system as recited in claim 5, further comprising a display screen connected to said processor for providing visual data input instruction to a user.
